(19) United States
(12) Patent Application Publication
(10) Pub. No.: US 2004/0159369 A1
(43) Pub. Date: Aug. 19, 2004

(54) Loosening device

(76) Inventor: Gilles Lessard, East-Broughton (CA)

Correspondence Address: Mr. Gilles Lessard, 672, Rang 6 Sud, East-Broughton, QC, GON 1GO, CA

(21) Appl. No.: 10/364,966

(22) Filed: Feb. 13, 2003

(51) Int. Cl. A01G 23/08; B66F 1/00

(52) U.S. Cl. 144/34.2; 254/104

(57) ABSTRACT

The present invention relates to manually operated device comprising a conical threaded part having in top an aperture for connecting a replaceable threaded screw which is engaged into a saw cut for loosen the guide bar of chain saw stucked into a tree, a cylindrical part having apertures is formed in bottom of the conical part for receiving a power bar having a connecting means at each end for receiving a circular handle member, and a lower part having a flat face with end generally circular is formed in bottom of the cylindrical part, which allows the user to use a crescent wrench if need be.

### BACKGROUND OF THE INVENTION

1) Field of the Invention

More paticularly, this invention relates to manually operated device for loosen the guide bar of chain saw into a saw cut which is stucked into a tree, and which can be used for the other similar utilities.

2) Description of the Related Art

A search of prior art records has unveiled the following United States patents:

1. CA 2,050,654 issued in 1992 to King;

2. U.S. Pat. No. 4,294,012 issued in 1981 to Lanz;

3. U.S. Pat. No. 4,130,270 issued in 1978 to Andersson;

4. U.S. Pat. No. 4,269,393 issued in 1981 to Michaud;

5. U.S. Pat. No. 4,875,514 issued in 1989 to Hollister; and

6. GB 1,602,790 issued in 1981 to Wickham.

The patents to King, Lanz, Andersson, Michaud, Hollister and Wickham are probably the most relevant.

To the present time it has been known to provide relatively mechanically operated apparatus or device for taking out the guide bar of chain saw into a saw cut which is stucked into a tree.

It is therefore an object of the present invention to provide a simple and effective device by which can be used with a minimum amount of effort on the part of the user for loosen the guide bar of chain saw into a saw cut which is stucked into a tree.

### SUMMARY OF THE INVENTION

According to the present invention there is provided a manually operated device comprising a conical threaded part having in top an aperture for connecting a replaceable threaded screw which is engaged into a saw cut when the guide bar of chain saw is stucked into a tree, a cylindrical part having apertures is formed in bottom of the conical part for receiving a power bar having a connecting means at each end for receiving a circular handle member, and a lower part having a flat face with end generally circular is formed in bottom of the cylindrical part, which allows the user to use a crescent wrench if need be.

### BRIEF DESCRIPTION OF THE SEVERAL VIEWS OF THE DRAWING(S)

The invention will now be described by way of example with reference to the accompanying drawings, in which:

FIG. 1 is a perspective view showing the device installed for loosen the guide bar of chain saw into a saw cut which is stucked into a tree;

FIG. 2 is a perspective view of device;

FIG. 3 is a plan view thereof; and

FIG. 4 is an exploded view thereof.

### DETAILED DESCRIPTION OF THE INVENTION

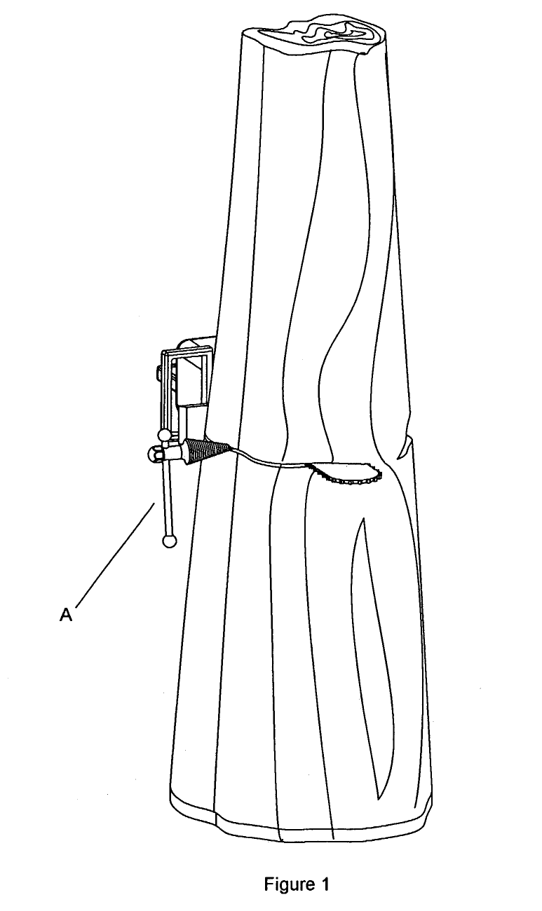

Referring now to the accompanying drawings, in FIG. 1 there is shown, a device (A) used for loosen the guide bar of chain saw into a saw cut which is stucked into a tree.

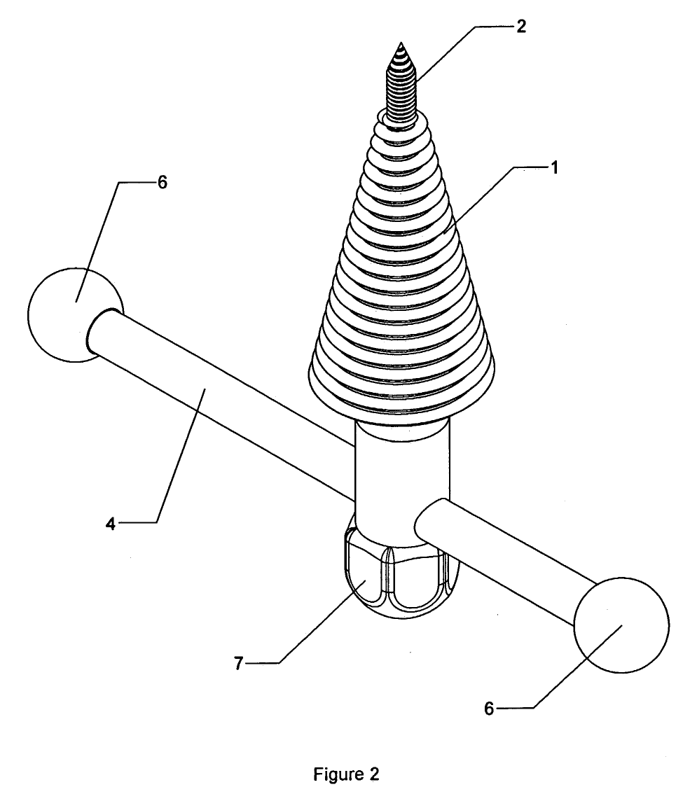

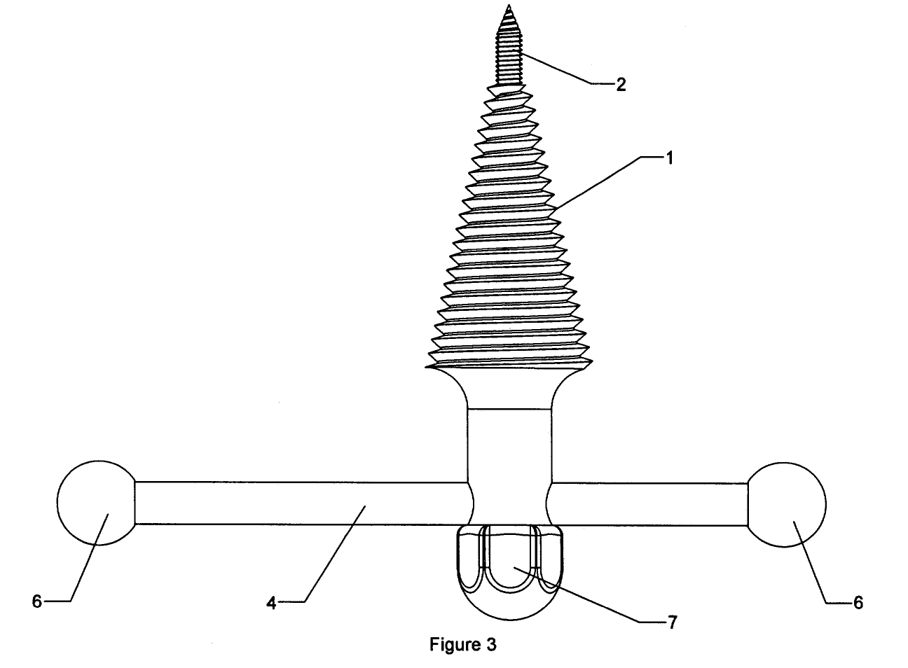

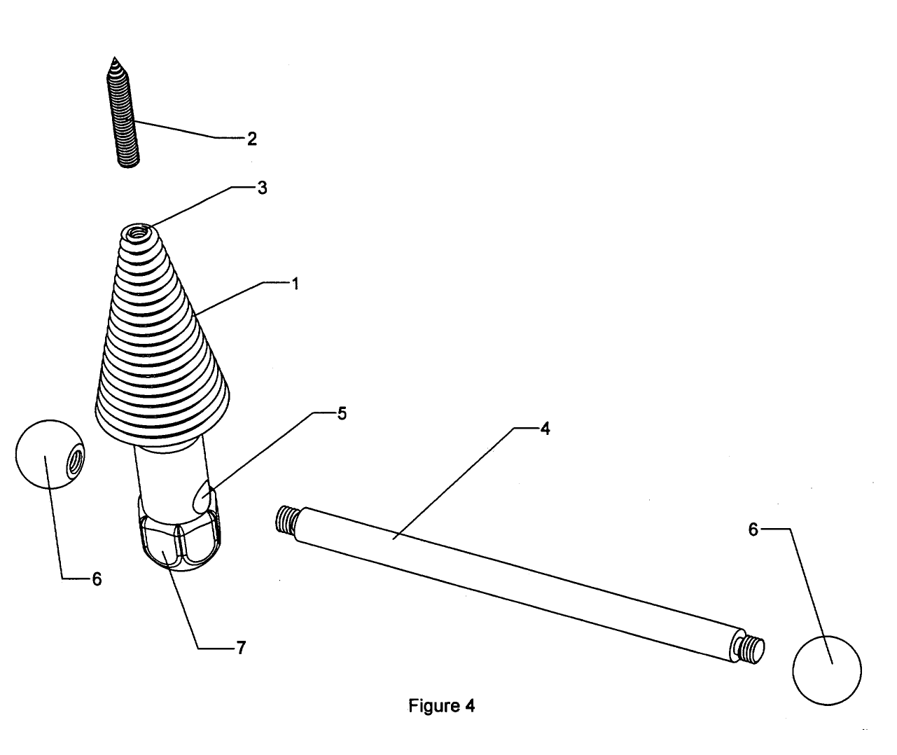

As shown in FIGS. 2 to 4, a manually operated device (A) comprising a conical threaded part (1) having in top an aperture (3) for connecting a replaceable threaded screw (2) which is engaged into a saw cut for loosen the guide bar of chain saw when it is stucked into a tree, a cylindrical part having apertures (5) is formed in bottom of the conical part (1) for receiving a power bar (4) having a connecting means at each end for receiving a circular handle member (6), and a lower part having a flat face (7) with end generally circular is formed in bottom of the cylindrical part having apertures (5), which allows the user to use a crescent wrench if need be.

Accordingly, while the preferred embodiments of the invention have been described above, it will be recognized and understood that various modifications may be made in the invention and the appended claims are intended to cover all such modifications which may fall within the spirit and scope of the invention.

The embodiments of the invention for which an exclusive property or privilege is claimed, are defined as follows:

I claim:

1. A manually operated device comprising:
a conical threaded part having in top an aperture for connecting a replaceable threaded screw which is engaged into a saw cut for loosen the guide bar of chain saw when it is thucked into a tree;
a cylindrical part having apertures is formed in bottom of said conical part for receiving a power bar;
said power bar having a connecting means at each end for receiving a circular handle member; and,
a lower part having a flat face with end generally circular is formed in bottom of said cylindrical part having apertures, which allows the user to use a crescent wrench if need be.
